(19) United States
(12) Patent Application Publication
(10) Pub. No.: US 2007/0011744 A1
(43) Pub. Date: Jan. 11, 2007

(54) Methods and systems for providing security from malicious software

(75) Inventors: Matthew E. Carothers, Atlanta, GA (US); Michael E. Cerrato, Atlanta, GA (US)

Correspondence Address: MERCHANT & GOULD PC, P.O. BOX 2903, MINNEAPOLIS, MN, 55402-0903, US

(73) Assignee: Cox Communications

(21) Appl. No.: 11/178,812

(22) Filed: Jul. 11, 2005

(51) Int. Cl. G06F 12/14

(52) U.S. Cl. 726/24

(57) ABSTRACT

Systems and methods are disclosed for providing security from malicious software. The disclosed systems and methods may include maintaining a malicious host database, the malicious host database containing a malicious host name corresponding to a malicious host. Furthermore, the disclosed systems and methods may include receiving, from a client, a service request including a first host name and querying the malicious host database to determine if the first host name corresponds to the malicious host name. Moreover, the disclosed systems and methods may include returning, to the client, a first address if it was determined that the first host name corresponds to the malicious host name.

### BACKGROUND OF THE INVENTION

I. Field of the Invention

The present invention generally relates to methods and systems for providing security. More particularly, the present invention relates to providing security from malicious software.

II. Background Information

Malicious software programs, comprising viruses and “trojan horses” for example, are designed to destroy, aggravate, and otherwise make life unhappy. A trojan horse, for example, is a program that appears legitimate, but performs some illicit activity when executed. For example, the trojan horse may be used to locate password information or make the system more vulnerable to future entry or simply destroy programs or data on a hard disk drive. A trojan horse is similar to a virus, except that it does not replicate itself. Rather, it stays in the computer doing its damage or allowing somebody from a remote site to take control of the computer. Trojan horses often sneak in a computer attached to a free game or other utility.

In some situations, a service provider's customer's computer may become infected with malicious software such as a trojan horse. For example, the customer may receive an e-mail that says “look at this great screen saver.” If the customer clicks on and executes the screen saver, the trojan horse may be executed and the computer may become completely under the control of some criminal element. The first thing the trojan horse may do is call it's home system. For example, it may connect back to the hacker who wrote the trojan horse and log into a hacker controlled server. From there, the hacker may issue commands to the infected computer. In connecting to the hacker controlled server, the trojan horse may use internet relay chat (IRC.) In other words, the infected computer acts as a chat client. For example, the infected computer logs into a chat server, joins a chat room, and then the hacker controls the infected computer just by talking in this chat control channel, giving specific command phrases.

One conventional strategy for dealing with trojan horses is to notify the customer when the server provider detects that the customer's computer is communicating with a hacker controlled server. It is not feasible, however, for the service provider to contact each infected customer and notify them to reformat their hard disk drive.

Another conventional strategy is to identify the aforementioned control channel and block access to the far end internet protocol (IP) address associated with the control channel (e.g. null routing.) For example, the service provider may instruct their routers not to send any traffic to the aforementioned control channel. According to this strategy, everything the trojan horse transmits back to the hacker controlled server is just dropped by the service provider's routers. The hacker never sees the computer call home. This is a good solution in that it keeps the customer from being exploited, however, it may not be a good solution in that it does nothing to fix the problem. For example, this conventional strategy does not give the service provider any awareness of which customers are infected and which are not. The hacker destine traffic is just dropped. However, the trojan horse is still furiously scanning on the customer's computer, thus substantially slowing the customer's computer down. Moreover, the hacker can change the hacker controlled server's IP address at will, thus rendering the aforementioned access blocking ineffective.

In view of the foregoing, there is a need for methods and systems for providing security. Furthermore, there is a need for providing security from malicious software.

### SUMMARY OF THE INVENTION

Consistent with embodiments of the present invention, systems and methods are disclosed for providing security from malicious software.

In accordance with one embodiment, a method for providing security from malicious software comprises maintaining a malicious host database, the malicious host database containing a malicious host name corresponding to a malicious host, receiving, from a client, a service request including a first host name, querying the malicious host database to determine if the first host name corresponds to the malicious host name, returning, to the client, a first address if it was determined that the first host name corresponds to the malicious host name.

According to another embodiment, a system for providing security from malicious software comprises a memory storage for maintaining a database and a processing unit coupled to the memory storage, wherein the processing unit is operative to maintain a malicious host database, the malicious host database containing a malicious host name corresponding to a malicious host, receive, from a client, a service request including a first host name, query the malicious host database to determine if the first host name corresponds to the malicious host name, and return, to the client, a first address if it was determined that the first host name corresponds to the malicious host name.

In accordance with yet another embodiment, a computer-readable medium which stores a set of instructions which when executed performs a method for providing security from malicious software, the method executed by the set of instructions comprising maintaining a malicious host database, the malicious host database containing a malicious host name corresponding to a malicious host, receiving, from a client, a service request including a first host name, querying the malicious host database to determine if the first host name corresponds to the malicious host name, and returning, to the client, a first address if it was determined that the first host name corresponds to the malicious host name.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary security providing system consistent with an embodiment of the present invention;

FIG. 2 is a block diagram of an exemplary security processor consistent with an embodiment of the present invention;

FIG. 3 is a flow chart of an exemplary method for providing security from malicious software consistent with an embodiment of the present invention; and

FIG. 4 is a flow chart of an exemplary subroutine used in the exemplary method of FIG. 3 for securing a malicious software module consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding stages to the disclosed methods. Accordingly, the following detailed description does not limit the invention. Instead, the proper scope of the invention is defined by the appended claims.

Systems and methods consistent with embodiments of the present invention provide security from malicious software. When two computers communicate with each other across the internet, for example, they do not use host names, instead, they use addresses such as IP addresses. An IP address is referred to as a “dotted quad” or a series of four groups of numbers separated by dots (i.e. 127.0.0.1). Each computer that is addressable on the internet has its own individual IP address.

Remembering long strings of numbers comprising IP addresses is not convenient for human beings. Accordingly, an overlay system has been created referred to as domain name service (DNS.) This is a service by which a host name may be associated with a corresponding IP address. An authoritative domain name service processor located on the internet may receive a service request and may provide an IP address associated with the corresponding domain name listed in the service request. A hacker controlled host may have a host name, for example, “FBI.bots.info” that points to one or more IP addresses where the hacker controlled servers are. A trojan horse may send a request (including a host name, for example, of “FBI.bots.info”) for DNS service from an infected computer. Even if the hacker controlled host's IP address gets blocked by the service provider or those control servers are removed by the responsible authorities, the hacker can just move their operation somewhere else. After the operation has been moved, the hacker can change the DNS entry to associate the hacker controlled host name with a new IP address, thus circumventing the service provider's blockage.

Consistent with embodiments of the invention, DNS service requests associated with known hacker controlled hosts may be blocked and redirected. For example, a service provider's customers may request DNS information from the service provider's DNS servers. (The service provider's DNS servers may be referred to as “resolvers” because they may resolve DNS.) Consistent with embodiments of the invention, the service provider's DNS servers may be fooled to think they are the authoritative DNS server for the hacker controlled host name. The service provider's DNS server can give the service provider's customer's request for DNS information a response.

For example, the service provider's DNS server may receive a request to resolve “FBI.bots.info”. Because the service provider's DNS server may know that this domain name is associated with a hacker, it may not forward this request to the proper authoritative DNS server. Rather, the service provider's DNS server may answer the request and return an IP address associated with a server controlled by the service provider. So now, when the customer's trojan infected computer tries to connect to “FBI.bots.info”, it ends up at a service provider controlled server and not a hacker controlled server. Accordingly, any private information or any other malicious behavior may be directed to and controlled by the service provider controlled server, which may mitigate the trojan's activity. Moreover, the hacker cannot get around this solution by merely moving their server to a different IP address when its discovered to be a hacker controlled server.

Another advantage is, in some situations, the service provider may be able to control the trojan horse once it connects with the service provider controlled server. For example, some trojan horses do not have passwords on them. Accordingly, the service provider controlled server may issue a command to uninstall the trojan horse. For example, in addition to logging chat room names, the passwords, and other information that can be used to further investigate the hacker, the service provider controlled server may uninstall the trojan horse. Furthermore, the trojan horse may be uninstalled without the infected customer knowing that they were infected and without contacting the customer.

An embodiment consistent with the invention may comprise a system for providing security from malicious software. The system may comprise a memory storage for maintaining a database and a processing unit coupled to the memory storage. The processing unit may be operative to maintain a malicious host database, the malicious host database containing a malicious host name corresponding to a malicious host. Furthermore, the processing unit may be operative to receive, from a client, a service request including a first host name and to query the malicious host database to determine if the first host name corresponds to the malicious host name. In addition, the processing unit may be operative to return, to the client, a first address if it was determined that the first host name corresponds to the malicious host name.

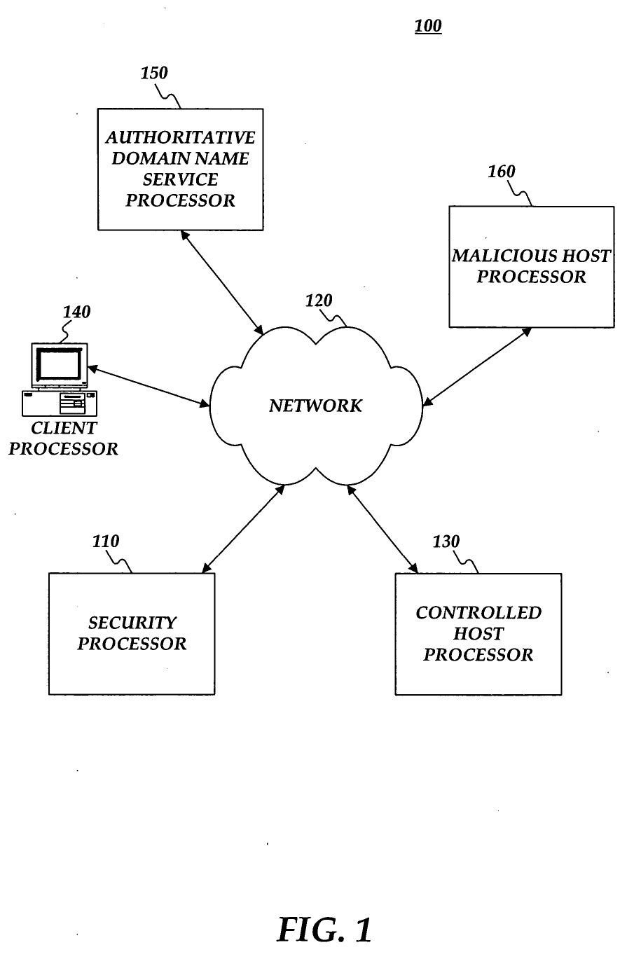

Consistent with an embodiment of the present invention, the aforementioned memory, processing unit, and other components may be implemented in a system for providing security from malicious software, such as an exemplary security providing system 100 of FIG. 1. Any suitable combination of hardware, software, and/or firmware may be used to implement the memory, processing unit, or other components. By way of example, the memory, processing unit, or other components may be implemented with any of a security processor 110 or a controlled host processor 130, in combination with system 100. The aforementioned system and processors are exemplary and other systems and processors may comprise the aforementioned memory, processing unit, or other components, consistent with embodiments of the present invention.

By way of a non-limiting example, FIG. 1 illustrates system 100 in which the features and principles of the present invention may be implemented. As illustrated in the block diagram of FIG. 1, system 100 may include security processor 110, a network 120, controlled host processor 130, a client processor 140, an authoritative domain name service processor 150, and a malicious host processor 160. Security processor 110 and controlled host processor 130 may comprise service provider controlled servers. Network 120 may comprise the internet. Client processor 140 may comprise a customer computer server by the service provider and infected with malicious software. Authoritative domain name service processor 150 may comprise the authoritative domain name service server. Malicious host processor 160 may comprise the hacker controlled server.

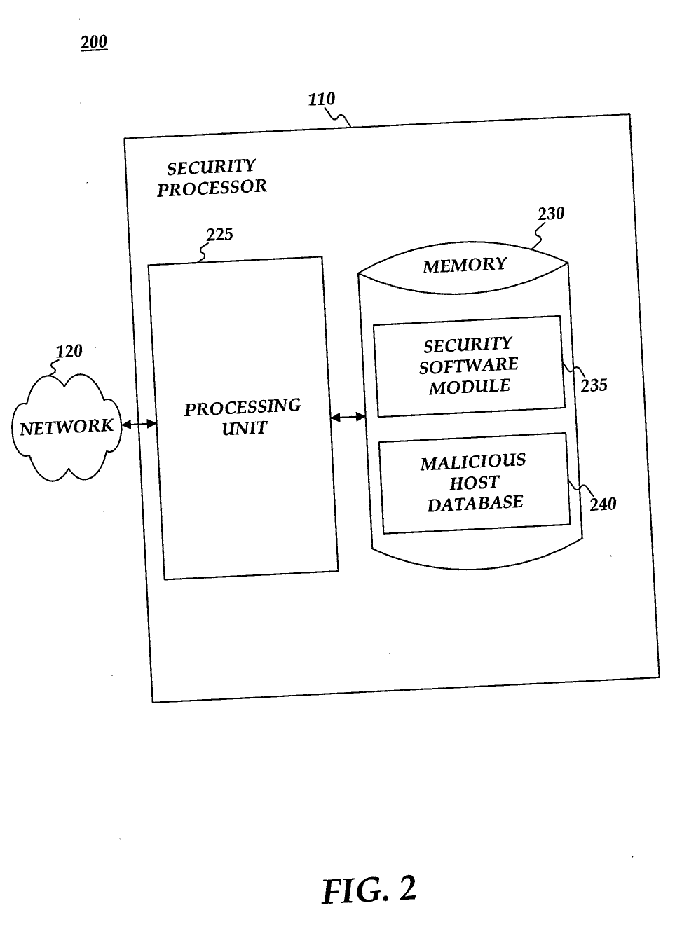

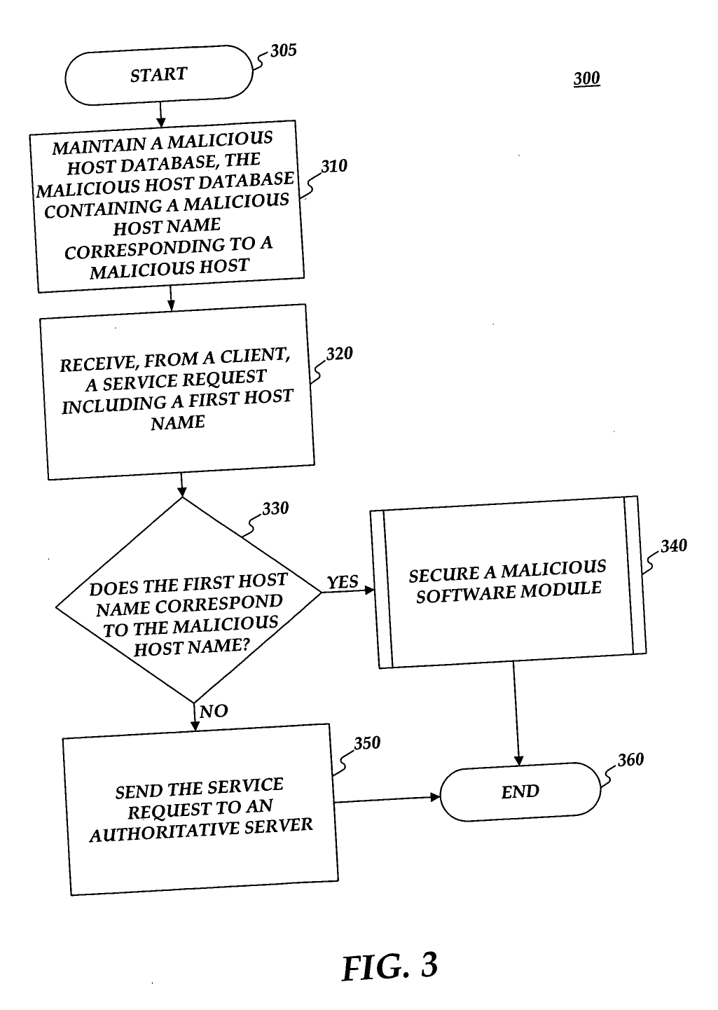

FIG. 2 shows security processor 110 of FIG. 1 in more detail. As shown in FIG. 2, security processor 110 may include a processing unit 225 and a memory 230. Memory 230 may include a security software module 235 and a malicious host database 240. While executing on processing unit 225, security software module 235 may perform processes for providing security from malicious software, including, for example, one or more of the stages of method 300 described below with respect to FIG. 3. Furthermore, any combination of software module 235 and database 240 may be executed on or reside in any one or more of security processor 110 and controlled host processor 130 as shown in FIG. 1.

Security processor 110, controlled host processor 130, client processor 140, authoritative domain name service processor 150, or malicious host processor 160 (“the processors”) included in system 100 may be implemented using a personal computer, network computer, mainframe, or other similar microcomputer-based workstation. The processors may though comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, any of the processors may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processor may comprise other systems or devices.

Network 120 may comprise, for example, a local area network (LAN) or a wide area network (WAN). Such networking environments are commonplace in offices, enterprise-wide computer networks, intranets, and the Internet. When a LAN is used as network 120, a network interface located at any of the processors may be used to interconnect any of the processors. When network 120 is implemented in a WAN networking environment, such as the Internet, the processors may typically include an internal or external modem (not shown) or other means for establishing communications over the WAN. Further, in utilizing network 120, data sent over network 120 may be encrypted to insure data security by using known encryption/decryption techniques.

In addition to utilizing a wire line communications system as network 120, a wireless communications system, or a combination of wire line and wireless may be utilized as network 120 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission. For example, the processors may communicate across a wireless interface such as, for example, a cellular interface (e.g., general packet radio system (GPRS), enhanced data rates for global evolution (EDGE), global system for mobile communications (GSM)), a wireless local area network interface (e.g., WLAN, IEEE 802.11), a bluetooth interface, another RF communication interface, and/or an optical interface.

System 100 may also transmit data by methods and processes other than, or in combination with, network 120. These methods and processes may include, but are not limited to, transferring data via, diskette, flash memory sticks, CD ROM, facsimile, conventional mail, an interactive voice response system (IVR), or via voice over a publicly switched telephone network.

FIG. 3 is a flow chart setting forth the general stages involved in an exemplary method 300 consistent with an embodiment of the invention for providing security from malicious software using system 100 of FIG. 1. Exemplary ways to implement the stages of exemplary method 300 will be described in greater detail below. Exemplary method 300 may begin at starting block 305 and proceed to stage 310 where security processor 110 may maintain malicious host database 240. Malicious host database 240 may contain a malicious host name corresponding to a malicious host. For example, the service provider may maintain malicious host database 240 with data obtained from a variety of different sources. Personnel associated with the service provider may be members of different industry-wide groups dedicated to identifying malicious hosts. From different industry-wide groups, the service provide may be made aware of certain malicious hosts and may update malicious host database 240 accordingly. Moreover, through other security related processes conducted by the service provider, the service provider may identify malicious hosts and may share this information with the different industry-wide groups.

From stage 310, where security processor 110 maintains malicious host database 240, exemplary method 300 may advance to stage 320 where security processor 110 may receive, from client processor 140, a service request including a first host name. For example, client processor 140 may wish to connect to a certain host. While client processor 140 may know the host name that it wishes to connect to, it may not know the address (e.g. IP address) associated with the desired host. Accordingly, the service provider may receive the service request from client processor 140 and then, it the conventional course, forward the service request to a proper authoritative domain name service processor for domain name service to find the address associated with the desired host.

Once security processor 110 receives the service request in stage 320, exemplary method 300 may continue to decision block 330 where security processor 110 may determine if the first host name correspond to the malicious host name. For example, rather than forwarding the service request to a proper authoritative domain name service processor, security processor 110 may first query malicious host database 240 with the host name contained in the service request. Accordingly, security processor 110 may determine if the host name contained in the service request is a known malicious host. In some instances, when the service request contains a known malicious host, client processor 140 that sent this service request may be controlled by (or otherwise infected with) malicious software such as a trojan horse.

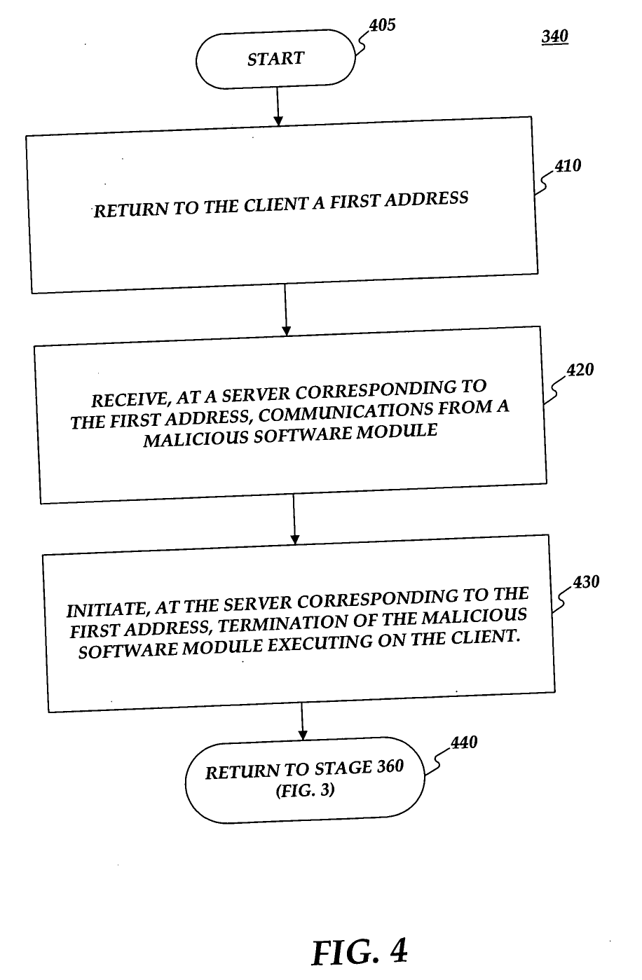

From decision block 330, if security processor 110 determines that the first host name correspond to the malicious host name, exemplary method 300 may proceed to exemplary subroutine 340 where a malicious software module on client processor 140 is secured. Exemplary ways to implement the stages of exemplary subroutine 340 will be described in greater detail below with respect to FIG. 4.

From decision block 330, if security processor 110 determines that the first host name does not correspond to the malicious host name, exemplary method 300 may proceed to stage 350 where security processor 110 may send the service request to authoritative domain name service processor 150. For example, if the host name contained in the service request is not a known malicious host, security processor 110 may forward the service request to a proper authoritative domain name service processor (e.g. service processor 150) for domain name service to find the address associated with the desired host. After security processor 110 sends the service request to authoritative domain name service processor 150 in stage 350, or from exemplary subroutine 340 where the malicious software module is secured, exemplary method 300 may then end at stage 360.

FIG. 4 describes exemplary subroutine 340 from FIG. 3 for securing the malicious software module. Exemplary subroutine 340 may begin at starting block 405 and proceed to stage 410 where security processor 110 may return to client processor 140 a first address. For example, security processor 110 may answer the request and return an address associated with a server controlled by the service provider (e.g. controlled host processor 130.) In other words, security processor 110 may return an IP address associated controlled host processor 130 rather than forwarding the request to the proper authoritative DNS server. In this way, security processor 110 may serve as the authoritative DNS server for the hacker controlled malicious host name.

From stage 410, where security processor 110 returns to the client processor 140 the first address, exemplary subroutine 340 may advance to stage 420 where controlled host processor 130 may receive communications from the malicious software module. For example, when malicious software on client processor 140 tries to connect to the malicious host, it ends up at the service provider controlled server, controlled host processor 130, and not a hacker controlled server. Accordingly, any private information or any other malicious behavior may be directed to and controlled by the service provider controlled server, which may mitigate the malicious software's activity. Moreover, the hacker cannot get around this solution by merely moving their server to a different IP address when its discovered to be a hacker controlled server.

Once controlled host processor 130 receives communications from the malicious software module in stage 420, exemplary subroutine 340 may continue to stage 430 where controlled host processor 130 may initiate termination of the malicious software module executing on client processor 140. For example, in some situations, the service provider may be able to control the malicious software once it connects with controlled host processor 130. For example, some malicious software programs do not have passwords on them. Accordingly, controlled host processor 130 may issue a command to uninstall the malicious software. For example, in addition to logging room names, passwords, and other information that can be used to further investigate the hacker, controlled host processor 130 may uninstall the malicious software. The malicious software may be uninstalled without the customer knowing that client processor 140 was infected and without contacting the customer. After controlled host processor 130 initiates termination of the malicious software module executing on client processor 140 in stage 430, exemplary subroutine 340 may then end at stage 440 and return to stage 360 of FIG. 3.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

The present invention may be embodied as systems, methods, and/or computer program products. Accordingly, the present invention may be embodied in hardware and/or in software (including firmware, resident software, micro-code, etc.). Furthermore, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention are described above with reference to block diagrams and/or operational illustrations of methods, systems, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

While certain features and embodiments of the invention have been described, other embodiments of the invention may exist. Furthermore, although embodiments of the present invention have been described as being associated with data stored in memory and other storage mediums, aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for providing security from malicious software, the method comprising:
maintaining a malicious host database, the malicious host database containing a malicious host name corresponding to a malicious host;
receiving, from a client, a service request including a first host name;
querying the malicious host database to determine if the first host name corresponds to the malicious host name; and
returning, to the client, a first address if it was determined that the first host name corresponds to the malicious host name.

2. The method of claim 1, wherein returning, to the client, the first address if it was determined that the first host name corresponds to the malicious host name further comprises returning, to the client, the first address not corresponding to the malicious host.

3. The method of claim 1, further comprising receiving, at a server corresponding to the first address, communications from a malicious software module executing on the client.

4. The method of claim 3, wherein receiving, at the server corresponding to the first address, communications further comprises receiving at the server corresponding to the first address, communications including personal information.

5. The method of claim 1, further comprising receiving, at a server corresponding to the first address, communications from a malicious software module characterized as a trojan horse.

6. The method of claim 1, further comprising initiating, at the server corresponding to the first address, termination of the malicious software module executing on the client.

7. The method of claim 1, further comprising sending the service request to an authoritative server if the first host name does not correspond to the malicious host name.

8. A system for providing security from malicious software, the system comprising:
a memory storage for maintaining a database; and
a processing unit coupled to the memory storage, wherein the processing unit is operative to
maintain a malicious host database, the malicious host database containing a malicious host name corresponding to a malicious host;
receive, from a client, a service request including a first host name;
query the malicious host database to determine if the first host name corresponds to the malicious host name; and
return, to the client, a first address if it was determined that the first host name corresponds to the malicious host name.

9. The system of claim 8, wherein the processing unit being operative to return, to the client, the first address if it was determined that the first host name corresponds to the malicious host name further comprises the processing unit being operative to return, to the client, the first address not corresponding to the malicious host.

10. The system of claim 8, further comprising the processing unit being operative to receive, at a server corresponding to the first address, communications from a malicious software module executing on the client.

11. The system of claim 10, wherein the processing unit being operative to receive, at the server corresponding to the first address, communications further comprises the processing unit being operative to receive at the server corresponding to the first address, communications including personal information.

12. The system of claim 8, further comprising the processing unit being operative to receive, at a server corresponding to the first address, communications from a malicious software module characterized as a trojan horse.

13. The system of claim 8, further comprising the processing unit being operative to initiate, at the server corresponding to the first address, termination of the malicious software module executing on the client.

14. The system of claim 8, further comprising the processing unit being operative to send the service request to an authoritative server if the first host name does not correspond to the malicious host name.

15. A computer-readable medium which stores a set of instructions which when executed performs a method for providing security from malicious software, the method executed by the set of instructions comprising:
maintaining a malicious host database, the malicious host database containing a malicious host name corresponding to a malicious host;
receiving, from a client, a service request including a first host name;
querying the malicious host database to determine if the first host name corresponds to the malicious host name; and
returning, to the client, a first address if it was determined that the first host name corresponds to the malicious host name.

16. The computer-readable medium of claim 15, wherein returning, to the client, the first address if it was determined that the first host name corresponds to the malicious host name further comprises returning, to the client, the first address not corresponding to the malicious host.

17. The computer-readable medium of claim 15, further comprising receiving, at a server corresponding to the first address, communications from a malicious software module executing on the client.

18. The computer-readable medium of claim 17, wherein receiving, at the server corresponding to the first address, communications further comprises receiving at the server corresponding to the first address, communications including personal information.

19. The computer-readable medium of claim 15, further comprising initiating, at the server corresponding to the first address, termination of the malicious software module executing on the client.

20. The computer-readable medium of claim 15, further comprising sending the service request to an authoritative server if the first host name does not correspond to the malicious host name.
